(19) United States
(12) Patent Application Publication
(10) Pub. No.: US 2025/0119951 A1
(43) Pub. Date: Apr. 10, 2025

(54) PHYSICAL RANDOM ACCESS CHANNEL (PRACH) RACH OCCASION (RO) SELECTION FOR AMBIENT INTERNET OF THINGS (IOT) SYSTEM WITH ASSISTING NODE

(71) Applicant: QUALCOMM Incorporated, San Diego, CA (US)

(72) Inventors: Qingjiang TIAN, San Diego, CA (US); Piyush GUPTA, Bridgewater, NJ (US); Jing SUN, San Diego, CA (US)

(21) Appl. No.: 18/483,335

(22) Filed: Oct. 9, 2023

(51) Int. Cl. H04W 74/08; H04B 7/155; H04W 72/542

(52) U.S. Cl. CPC H04W 74/0833; H04B 7/155; H04W 72/542

(57) ABSTRACT

Certain aspects of the present disclosure provide a method for wireless communications at an ambient internet of things (IoT) device. The ambient IoT device measures signal strength of a downlink signal transmitted from a gNodeB (gNB). The ambient IoT device estimates a pathloss between the gNB and itself based at least on the measured signal strength. Based on the pathloss between the ambient IoT device and the gNB, and together with measured received power from an assisting node, the ambient IoT device may select a random access channel (RACH) occasion (RO) so that a received power at the gNB from the ambient IoT device is constrained to a limited range.

### BACKGROUND

### Field of the Disclosure

Aspects of the present disclosure relate to wireless communications, and more particularly, to techniques for managing selection of random access channel (RACH) occasions (ROs) for an RACH procedure in an ambient internet of things (IoT) system.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communications at a first wireless node. The method includes measuring one or more signals received from a second wireless node; measuring a continuous wave (CW) received from a third wireless node; selecting a random access channel (RACH) occasion (RO) based on measurements associated with the one or more signals and the CW; and transmitting an RACH transmission in the selected RO.

Other aspects provide: an apparatus operable, configured, or otherwise adapted to perform the aforementioned methods as well as those described elsewhere herein; a non-transitory, computer-readable media comprising instructions that, when executed by one or more processors of an apparatus, cause the apparatus to perform the aforementioned methods as well as those described elsewhere herein; a computer program product embodied on a computer-readable storage medium comprising code for performing the aforementioned methods as well as those described elsewhere herein; and an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station (BS) architecture.

FIG. 3 depicts aspects of an example BS and an example user equipment (UE).

FIG. 4A, FIG. 4B, FIG. 4C, and FIG. 4D depict various example aspects of data structures for a wireless communications network.

FIG. 5 depicts a radio frequency identification (RFID) system.

FIG. 6 depicts an example diagram illustrating ambient internet of things (IoT) devices.

FIG. 7 depicts an example diagram illustrating a first topology of an ambient IoT system.

FIG. 8 depicts an example diagram illustrating a second topology of an ambient IoT system.

FIG. 9 depicts an example diagram illustrating a third topology of an ambient IoT system with downlink assistance.

FIG. 10 depicts an example diagram illustrating a third topology of an ambient IoT system with uplink assistance.

FIG. 11 depicts example random access channel (RACH) occasions (ROs) in different slots.

FIG. 12 depicts a first call flow diagram illustrating example communication among different devices and nodes for managing selection of one or more ROs for an RACH procedure in an ambient IoT system with an assisting node for downlink operations.

FIG. 13 depicts a second call flow diagram illustrating example communication among different devices and nodes for managing selection of one or more ROs for an RACH procedure in an ambient IoT system with an assisting node for uplink operations.

FIG. 14 depicts a method for wireless communications at a first wireless node for managing selection of one or more ROs for an RACH procedure in an ambient IoT system.

FIG. 15 depicts an example communications device.

### DETAILED DESCRIPTION

Aspects of the present disclosure provide apparatuses, methods, processing systems, and computer-readable mediums for managing selection of one or more random access channel (RACH) occasions (ROs) for an RACH procedure in an ambient internet of things (IoT) system.

An ambient IoT device (or tag) refers to a device that is much smaller and cheaper compared to previous generations of IoT devices, such as narrowband IoT (NB-IoT) and reduced capability (RedCap) devices. The ambient IoT device may obtain energy from radio waves. Due to its size and ability to operate with little or no power source, the ambient IoT device may have broad applicability in tracking, monitoring, and managing various devices and processes. The ambient IoT system may include a gNodeB (gNB) to communicate with different ambient IoT devices.

RACH stands for random access channel. It is an essential part of wireless systems, including 5G new radio (NR). RACH procedure plays a role in establishing an initial connection between a user equipment (UE) and a gNB. The UE (e.g., the ambient IoT device) may initiate the RACH procedure after receiving a downlink synchronization signal block (SSB) signal from the gNB. In some cases, there may be a one-to-one correspondence between the received SSB and an RO (e.g., that can be used by the ambient IoT device for an RACH transmission).

In some ambient IoT systems, there may be multiple ambient IoT devices in a cell. In such systems, it is possible that more than one ambient IoT device may select a same RO for a physical RACH (PRACH) transmission (e.g., when the multiple ambient IoT devices located at similar or different distances from the gNB may receive a same SSB from the gNB). In such cases, to achieve satisfying initial access performance for all the ambient IoT devices selecting the same RO, it is desirable to have a same receiving power from the ambient IoT devices.

The ambient IoT device may not have a capability of power control. So, when the multiple ambient IoT devices may use the same RO for the PRACH transmissions, then the received power of the PRACH transmissions from the different ambient IoT devices may be significantly different. For example, the ambient IoT device that may be at an edge of the cell may fail the RACH procedure, which may lead to excess delay and more energy consumption for successfully completing the RACH procedure.

Since the ambient IoT device may not have the capability of power control, one solution is to provide more than one RO (e.g., an RO pool with multiple ROs) corresponding to one SSB. For example, by providing more than one RO for the SSB, it may be possible to have a similar received signal power at a reader (e.g., which may receive transmissions from the ambient IoT devices using the RO pool).

Techniques described herein may assist an ambient IoT device to select an RO from an RO pool in an ambient IoT system (e.g., with an assisting node for downlink or uplink operations) such that a received power of a signal from the ambient IoT device is constrained to a limited range.

For example, the ambient IoT device may measure signal strength of a downlink signal from a gNB. Based on signal strength measurements, the ambient IoT device may estimate a pathloss between the gNB and the ambient IoT device. Based on the estimated pathloss and other measurements (such as a received power of a signal from the assisting node), the ambient IoT device may select the RO (e.g., with a shorter or longer sequence) such that the received power of the signal at the gNB transmitted from the ambient IoT device at the selected RO is constrained to a limited range.

In another example, the ambient IoT device may measure signal strength of a sounding signal from the assisting node. Based on signal strength measurements, the ambient IoT device may estimate a pathloss between the assisting node and the ambient IoT device. Based on the estimated pathloss and other measurements (such as the received power of the signal from the gNB), the ambient IoT device may select the RO such that the received power of the signal at the assisting node transmitted from the ambient IoT device at the selected RO is constrained to a limited range.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

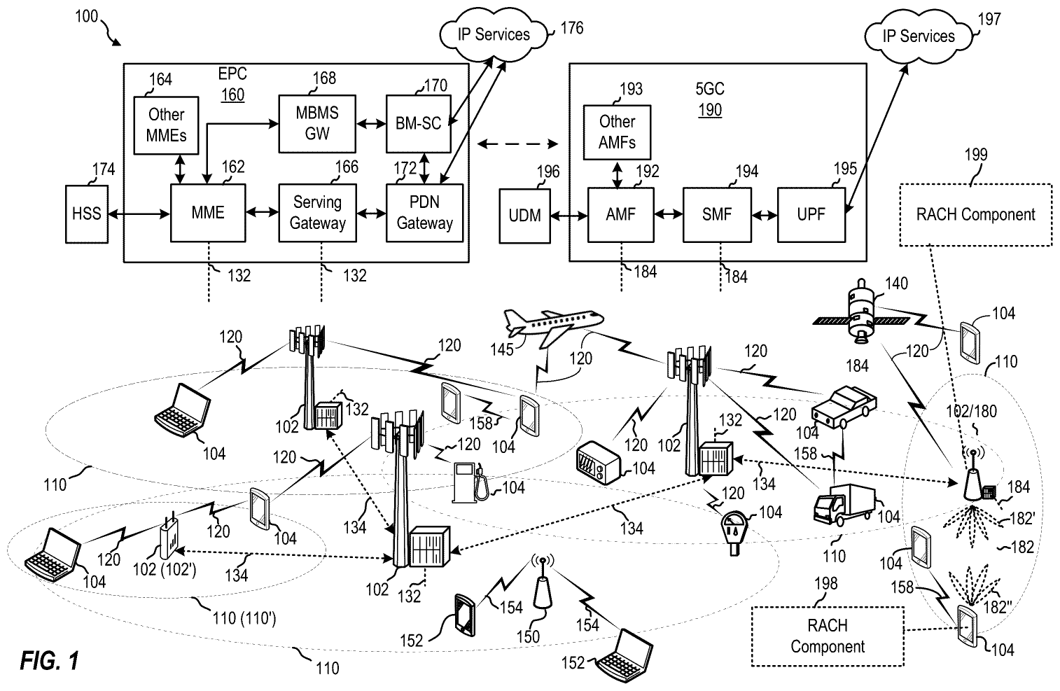

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and UEs.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio BS, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

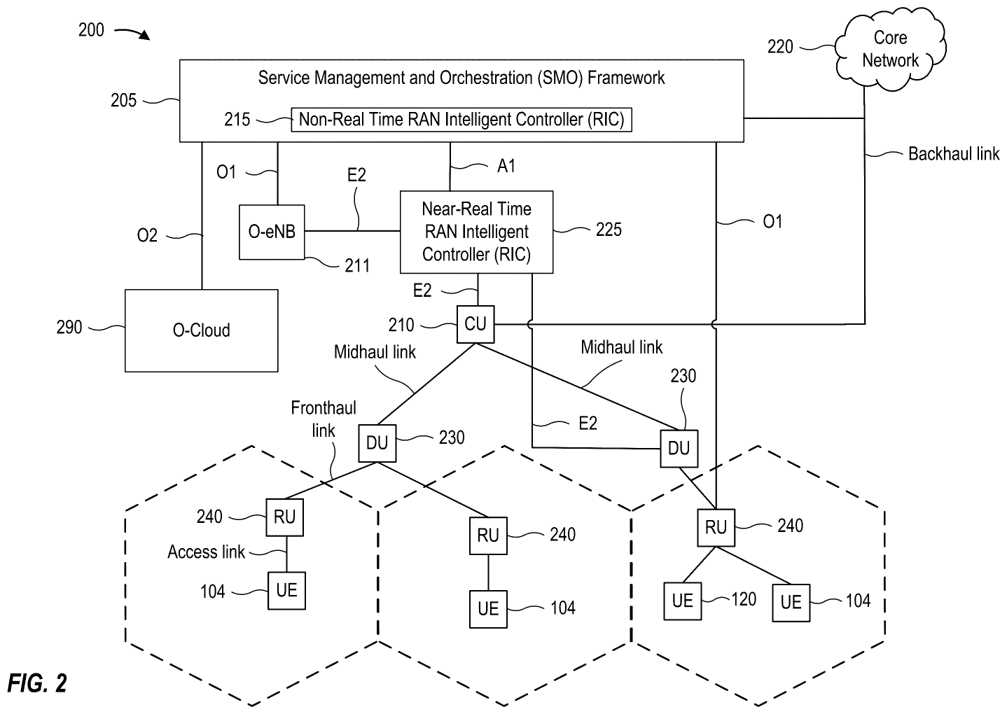

While BSs 102 are depicted in various aspects as unitary communications devices, BSs 102 may be implemented in various configurations. For example, one or more components of a BS 102 may be disaggregated, including a central unit (CU), one or more distributed units (Dus), one or more radio units (Rus), a Near-Real Time (Near-RT) RAN Intelligent Controller (RIC), or a Non-Real Time (Non-RT) RIC, to name a few examples. In another example, various aspects of a BS 102 may be virtualized. More generally, a BS (e.g., BS 102) may include components that are located at a single physical location or components located at various physical locations. In examples in which a BS 102 includes components that are located at various physical locations, the various components may each perform functions such that, collectively, the various components achieve functionality that is similar to a BS 102 that is located at a single physical location. In some aspects, a BS 102 including components that are located at various physical locations may be referred to as a disaggregated radio access network (RAN) architecture, such as an Open RAN (O-RAN) or Virtualized RAN (VRAN) architecture. FIG. 2 depicts and describes an example disaggregated BS architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 600 MHz-6 GHz, which is often referred to (interchangeably) as “Sub-6 GHz”. Similarly, 3GPP currently defines Frequency Range 2 (FR2) as including 26-41 GHz, which is sometimes referred to (interchangeably) as a “millimeter wave” (“mmW” or “mmWave”). A BS configured to communicate using mmWave/near mmWave radio frequency bands (e.g., a mmWave BS such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain BSs (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

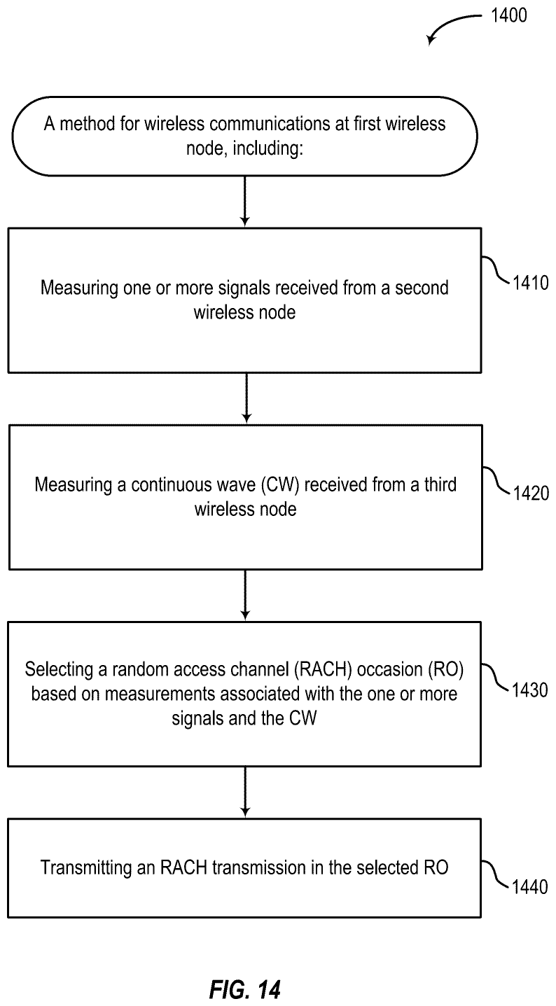

Wireless communication network 100 further includes random access channel (RACH) component 198, which may be configured to perform method 1400 of FIG. 14. Wireless communication network 100 further includes RACH component 199, which may be configured to perform method 1400 of FIG. 14.

In various aspects, a network entity or network node can be implemented as an aggregated BS, as a disaggregated BS, a component of a BS, an integrated access and backhaul (IAB) node, a relay node, a sidelink node, to name a few examples.

FIG. 2 depicts an example disaggregated BS 200 architecture. The disaggregated BS 200 architecture may include one or more central units (Cus) 210 that can communicate directly with a core network 220 via a backhaul link, or indirectly with the core network 220 through one or more disaggregated BS units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (Dus) 230 via respective midhaul links, such as an F1 interface. The Dus 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more BS functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via 01) or via creation of RAN management policies (such as A1 policies).

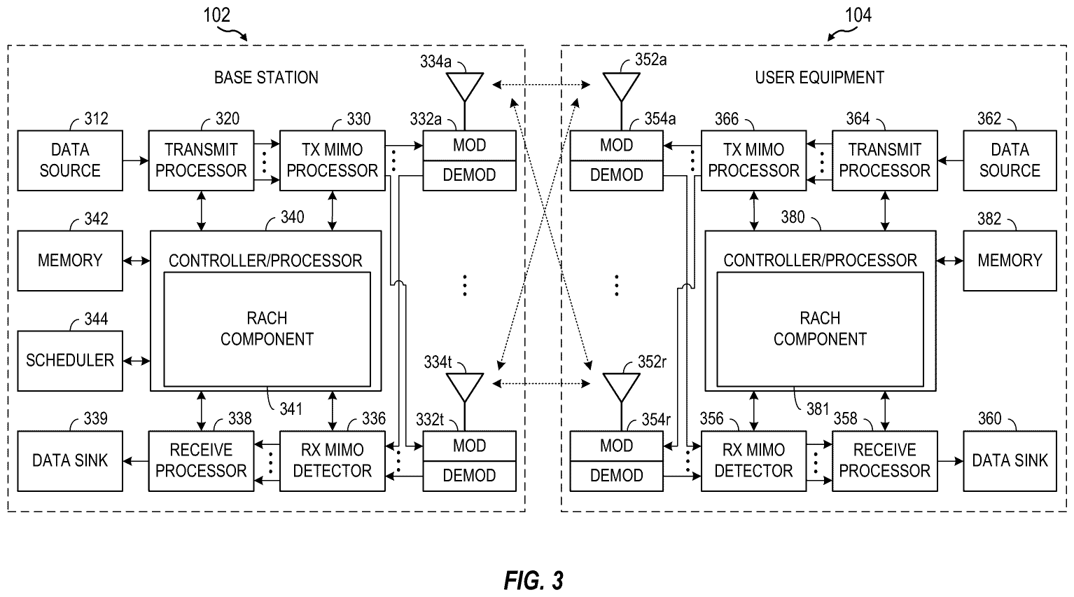

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

BS 102 includes controller/processor 340, which may be configured to implement various functions related to wireless communications. In the depicted example, controller/processor 340 includes RACH component 341, which may be representative of RACH component 199 of FIG. 1. Notably, while depicted as an aspect of controller/processor 340, RACH component 341 may be implemented additionally or alternatively in various other aspects of BS 102 in other implementations.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

UE 104 includes controller/processor 380, which may be configured to implement various functions related to wireless communications. In the depicted example, controller/processor 380 includes RACH component 381, which may be representative of RACH component 198 of FIG. 1. Notably, while depicted as an aspect of controller/processor 380, RACH component 381 may be implemented additionally or alternatively in various other aspects of UE 104 in other implementations.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the SRS). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs 104 for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

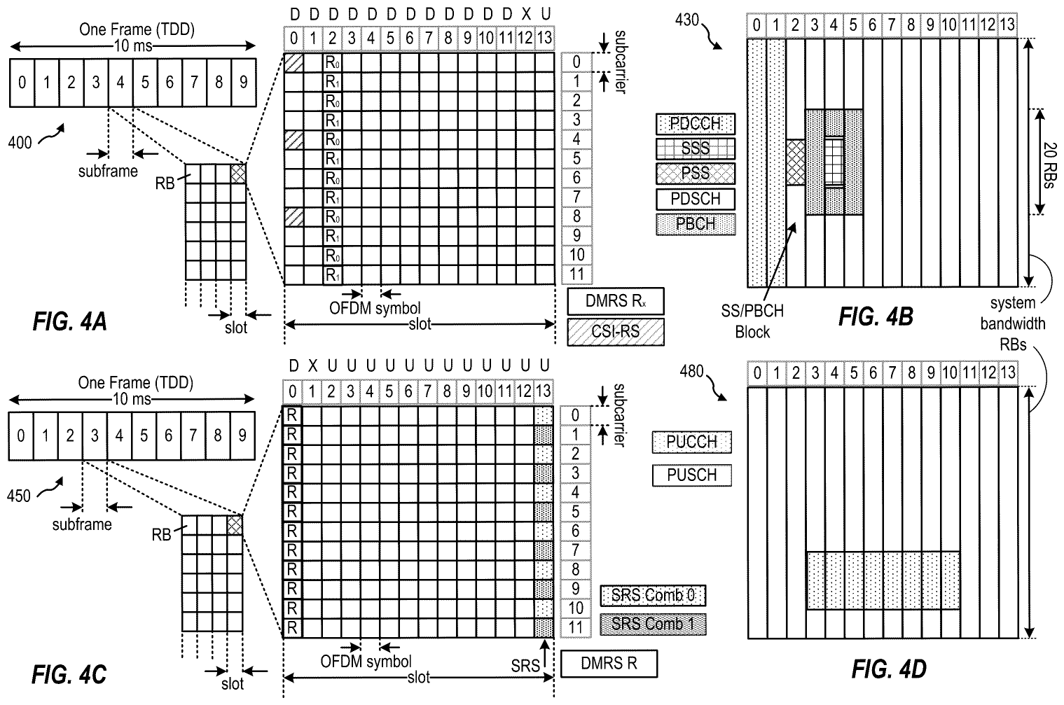

FIG. 4A, FIG. 4B, FIG. 4C, and FIG. 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIG. 4B and FIG. 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be TDD, in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs 104 may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2^{μ}×15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIG. 4A, FIG. 4B, FIG. 4C, and FIG. 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIG. 4A, FIG. 4B, FIG. 4C, and FIG. 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIG. 1 and FIG. 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIG. 1 and FIG. 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the BS. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a BS for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Introduction to mmWave Wireless Communications

In wireless communications, an electromagnetic spectrum is often subdivided into various classes, bands, channels, or other features. The subdivision is often provided based on wavelength and frequency, where frequency may also be referred to as a carrier, a subcarrier, a frequency channel, a tone, or a subband.

5^{th} generation (5G) networks may utilize several frequency ranges, which in some cases are defined by a standard, such as 3^{rd} generation partnership project (3GPP) standards. For example, 3GPP technical standard TS 38.101 currently defines Frequency Range 1 (FR1) as including 600 MHz-6 GHz, though specific uplink and downlink allocations may fall outside of this general range. Thus, FR1 is often referred to (interchangeably) as a “Sub-6 GHz” band.

Similarly, TS 38.101 currently defines Frequency Range 2 (FR2) as including 26-41 GHz, though again specific uplink and downlink allocations may fall outside of this general range. FR2, is sometimes referred to (interchangeably) as a “millimeter wave” (“mmW” or “mmWave”) band, despite being different from the extremely high frequency (EHF) band (30 GHz-300 GHz) that is identified by the International Telecommunications Union (ITU) as a “millimeter wave” band because wavelengths at these frequencies are between 1 millimeter and 10 millimeters.

Communications using mmWave/near mmWave radio frequency band (e.g., 3 GHz-300 GHz) may have higher path loss and a shorter range compared to lower frequency communications. As described above with respect to FIG. 1, a base station (BS) (e.g., 180) configured to communicate using mmWave/near mmWave radio frequency bands may utilize beamforming (e.g., 182) with a user equipment (UE) (e.g., 104) to improve path loss and range.

### Overview of Radio Frequency Identification (RFID) Systems

Radio frequency identification (RFID) is a rapidly growing technology impacting many industries due to its economic potential for inventory/asset management within warehouses, internet of things (IoT), sustainable sensor networks in factories and/or agriculture, and smart homes, to name a few example applications. RFID technology consists of RFID devices (or backscatter devices), such as transponders, or tags, that emit an information-bearing signal upon receiving an energizing signal.

RFID devices may be operated without a battery. Generally, RFID devices that are operated without a battery are known as passive RFID devices. Passive RFID devices may operate by harvesting energy from received radio frequency signals (e.g., “over the air”), thereby powering reception and transmission circuitry within the RFID devices. This harvested energy allows passive RFID devices to transmit information, sometimes referred to as backscatter modulated information, without the need for a local power source within the RFID device. On the other hand, in certain aspects, RFID device may be semi-passive and include on-board energy storage to supplement their ability to harvest energy from received signals (however, at higher cost).

In some cases, in addition to harvesting power from RF sources, energy harvesting devices may accumulate energy from other direct energy sources, such as solar energy, in order to supplement its power demands. Semi-passive energy harvesting devices may, in some cases, include power consuming RF components, such as analog to digital converters (ADCs), mixers, and oscillators.

The RFID device may be a type of user equipment (UE) that provides low-cost and low-power solutions for many applications in a wireless communications system. The RFID device may be power efficient, sometimes requiring less than 0.1 mW of power to operate. Further, relatively simple architectures and, in some cases, lack of battery, mean that the RFID device can be small, lightweight, and easily installed or integrated in many types of environments or host devices. The RFID device provides practical and necessary solutions to many networking applications that require, low-cost, small footprint, durable, maintenance-free, and long lifespan communications devices. For example, the RFID device may be configured as long endurance industrial sensors, which mitigates the problems of replacing batteries in and around dangerous machinery.

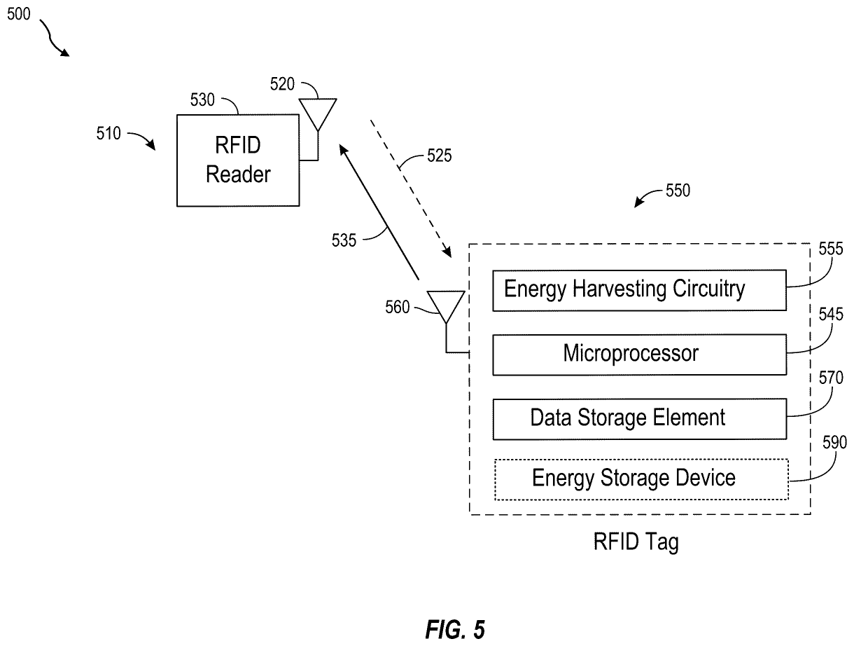

FIG. 5 shows an RFID system 500. As shown, RFID system 500 includes a reader 510 and an RFID tag 550. Reader 510 may also be referred to as an interrogator or a scanner. RFID tag 550 may also be referred to as an interrogator, RFID label, or an electronics label. In certain aspects, reader 510 is a network entity (e.g., such as a gNB) and RFID tag 550 is a user equipment (UE).

Reader 510 includes an antenna 520 and an electronics unit 530. Antenna 520 radiates signals transmitted by reader 510 and receives signals from RFID tags and/or other devices. Electronics unit 530 may include a transmitter and a receiver for reading RFID tags such as RFID tag 550. The same pair of transmitter and receiver (or another pair of transmitter and receiver) may support bi-directional communication with wireless networks, wireless devices, etc. Electronics unit 530 may include processing circuitry (e.g., a processor) to perform processing for data being transmitted and received by the RFID reader 510.

RFID tag 550 includes an antenna 560 and a data storage element 570. Antenna 560 radiates signals transmitted by RFID tag 550 and receives signals from RFID reader 510 and/or other devices. Data storage element 570 stores information for RFID tag 550, for example, in an electrically erasable programmable read-only memory (EEPROM) or another type of memory. RFID tag 550 may also include an electronics unit that can process the received signal and generate the signals to be transmitted.

RFID tag 550 may be a passive RFID tag having no battery. In this case, induction may be used to power the RFID tag 550. For example, in some cases, a magnetic field from a signal transmitted by reader 510 may induce an electrical current in RFID tag 550, which may then operate based on the induced current. RFID tag 550 can radiate its signal in response to receiving a signal from RFID reader 510 or some other device. In certain other aspects, RFID tag 550 may optionally include an energy storage device 590, such as a battery, capacitor, etc., for storing energy harvested using energy harvesting circuitry 555, as described below.

RFID tag 550 may be read by placing the reader 510 within close proximity to RFID tag 550. Reader 510 may radiate a first signal 525 via the antenna 520. In some cases, the first signal 525 may be known as an interrogation signal or energy signal. In some cases, energy of the first signal 525 may be coupled from reader antenna 520 to RFID tag antenna 560 via magnetic coupling and/or other phenomena. In other words, the RFID tag 550 may receive the first signal 525 from reader 510 via antenna 560 and energy of the first signal 525 may be harvested using energy harvesting circuitry 555 (e.g., an RF transducer) and used to power RFID tag 550. For example, energy of the first signal 525 received by RFID tag 550 may be used to power a microprocessor 545 of RFID tag 550. Microprocessor 545 may, in turn, retrieve information stored in a data storage element 570 of RFID tag 550 and transmit the retrieved information via a second signal 535 using the antenna 560. For example, in some cases, microprocessor 545 may generate the second signal 535 by modulating a baseband signal (e.g., generated using energy of the first signal 525) with the information retrieved from the data storage element 570. In some cases, this second signal 535 may be known as a backscatter modulated information signal. Thereafter, as noted, microprocessor 545 transmits the second signal 535 to reader 510. Reader 510 may receive the second signal 535 from RFID tag 550 via antenna 520 and may process (e.g., demodulate) the received signal to obtain the information of data storage element 570 sent in second signal 535.

RFID system 500 may be designed to operate at 13.56 MHz or some other frequency (e.g., an ultra-high frequency (UHF) band at 900 MHz). Reader 510 may have a specified maximum transmit power level, which may be imposed by the Federal Communication Commission (FCC) in the United Stated or other regulatory bodies in other countries. The specified maximum transmit power level of reader 510 may limit the distance at which RFID tag 550 can be read by reader 510.

Wireless technology is increasingly useful in industrial applications, such as ultra-reliable low-latency communication (URLLC) and machine type communication (MTC). In such domains, and others, it is desirable to support devices (e.g., passive RFID tags) that are capable of harvesting energy from wireless energy sources (e.g., in lieu of or in combination with a battery or other energy storage device, such as a capacitor), such as RF signals, thermal energy, solar energy, and the like.

### Overview of Backscatter Communication Process

Wireless technology is increasingly useful in industrial applications, such as ultra-reliable low-latency communication (URLLC) and machine type communication (MTC). In such domains, and others, it is desirable to support devices (e.g., passive radio frequency identification (RFID) tags) that are capable of harvesting energy from wireless energy sources (e.g., in lieu of or in combination with a battery or other energy storage device, such as a capacitor), such as radio frequency (RF) signals, thermal energy, solar energy, and the like.

For example, in some cases, these devices may not include a local power storage component and may instead harvest energy from things such as RF signals, thermal energy, solar energy, etc. In some cases, these devices may be known as passive internet of things (PIoT) devices or more generally as zero power internet of things (ZP-IoT) devices. ZP-IoT devices may employ RFID-type technology and, as such, may not include a local power source. Instead, ZP-IoT devices may harvest energy from radio signals emitted from a reader device, such as a network entity or a user equipment (UE), for performing data collection, transmission and distributed computing.

ZP-IoT devices may have different use cases. For example, one ZP-IoT use case includes an industrial sensor use case where replacing batteries of communication devices is prohibitively difficult or undesirable (e.g., for safety monitoring or fault detection in smart factories, infrastructures, or environments). Another ZP-IoT use case includes a smart logistics/warehousing use case in which extremely-low cost, small size, maintenance-free, durable, long lifespan communication devices are used, for example, for performing automated asset management in factories. Another ZP-IoT use case includes a smart home network for household item management, wearables, and environment monitoring (e.g., a wearable device for medical monitoring where that does not require battery replacement).

As noted above, ZP-IoT devices may be capable of harvesting energy from one or more wireless energy sources, such as RF signals, thermal energy, solar energy, etc. In some cases, when RF signals are used to harvest energy, a first device (e.g., the BS 102 depicted and described with respect to FIG. 1 and FIG. 3, or the disaggregated BS depicted and described with respect to FIG. 2; the UE 104 depicted and described with respect to FIG. 1 and FIG. 3; or any other device described herein capable of transmitting wireless signals) may transmit an energy signal to a second device, such as a ZP-IoT device (e.g., the UE 104, the RFID tag 550 depicted and described with respect to FIG. 5, etc.). The second device may then harvest energy from the energy signal (e.g., using the energy harvesting circuitry 555 depicted and described with respect to FIG. 5) and use this harvested energy to power one or more other components of the second device. In some cases, a portion of the harvested energy may be used to charge a local energy storage device of the second device for later use (i.e., the harvested energy may be stored in the local power storage component). After a sufficient amount of energy is accumulated, the second device may begin to reflect the energy signal radiated onto the second device, known as a backscatter signal or backscatter communication. When reflecting the energy signal, the second device may modulate a particular on-off pattern, corresponding to a set of transmission bits, onto the energy signal. The first device or a third device (e.g., a reader device) may detect and demodulates the reflected pattern, thereby obtaining the set of transmission bits.

In some cases, the RF signals used for energy harvesting for ZP-IoT communication may be encoded using an encoding scheme. In some cases, the encoding scheme may include a manchester encoding scheme, a pulse interval encoding (PIE) scheme, or another encoding scheme used for RFID-based communication.

In some cases, the backscatter communication may refer to a mechanism that allows wireless devices, often referred to as RFID tags, to communicate without active RF components. In a typical scenario, an RFID tag obtains (harvests) energy from an RF transmission from a reader and is also able to modulate and reflect the signals back to the reader (hence, the term backscatter). The signal reflection results from designed mismatch between an antenna and a load impedance at the RFID tag. In some cases, the load impedance can be varied to modulate the reflected signal with information bits the reader can recover by demodulating the reflected signals.

### Overview of Ambient Internet of Things (IoT) Devices

An ambient internet of things (IoT) device (or tag) refers to a device that is much smaller and cheaper compared to previous generations of IoT devices, such as narrowband IoT (NB-IoT) and reduced capability (RedCap) devices. Ambient IoT devices may obtain energy from radio waves. Due to their size and ability to operate with little or no power source, ambient IoT device may have broad applicability in tracking, monitoring, and managing various devices and processes, with consumer and industrial uses.

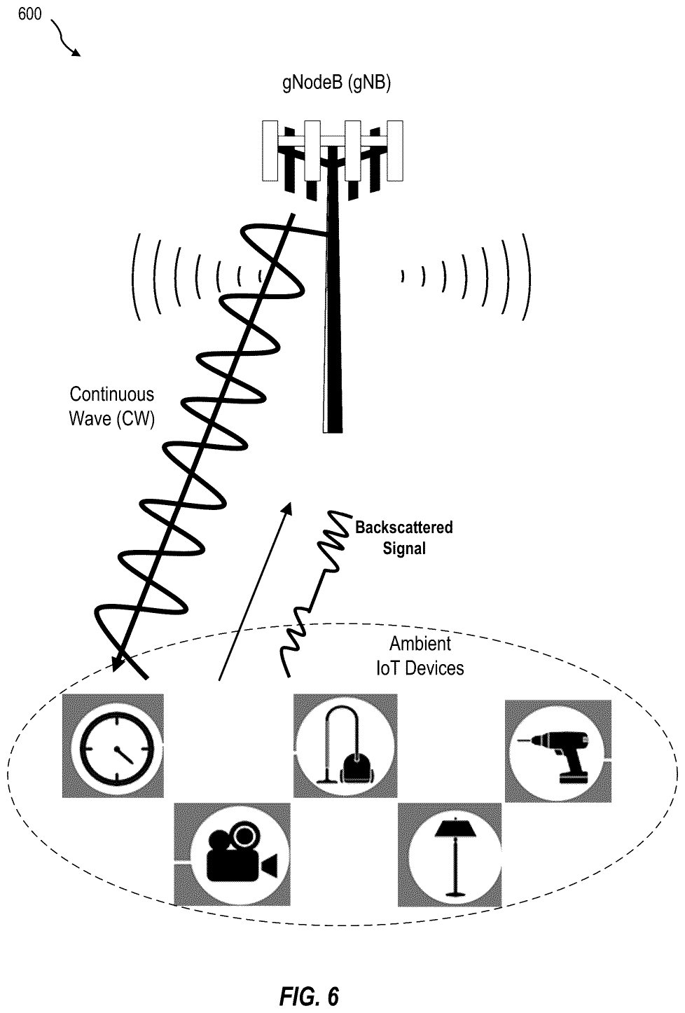

FIG. 6 depicts an example system 600 (e.g., an ambient IoT system) that utilizes a network entity (e.g., a gNodeB (gNB)) to communicate with ambient IoT devices. The ambient IoT devices may be used to monitor a variety of devices and processes. For example, the ambient IoT devices may be used to report sensor measurements, video signals/images, light readings, and control devices (e.g., as actuators).

Typical networks may not be able to efficiently support the most pervasive radio frequency identification (RFID) type of sensors, implemented as passive IoT devices. Such devices may be used extensively in future use cases, such as asset management, logistics, warehousing and manufacturing. Certain systems may be required to manage ambient IoT devices.

As illustrated in FIG. 6, a gNB may be able to read information stored on one or more ambient IoT devices and/or write information to the one or more ambient IoT devices. The gNB can provide energy to the one or more ambient IoT devices (e.g., via a continuous wave (CW) signal), and an information-bearing signal may be reflected back (e.g., backscattered) from the one or more ambient IoT devices to the gNB. The gNB may read the reflected signal (e.g., a backscattered signal) from the one or more ambient IoT devices to decode information transmitted by the one or more ambient IoT devices.

The ambient IoT devices may support various types of traffic. For example, ambient IoT devices may support Device-Originated (DO) traffic, including Device-Originated autonomous (DO-DOA) and Device-Terminated triggered (DO-DTT) traffic, which may be reported periodically.

The ambient IoT system is associated with different topologies such as a first topology, a second topology, a third topology with downlink assistance, and a third topology with uplink assistance. In all these topologies, an ambient IoT device may be provided with a carrier wave from other node(s) either inside or outside the topology. One or more links in each topology may be bidirectional or unidirectional.

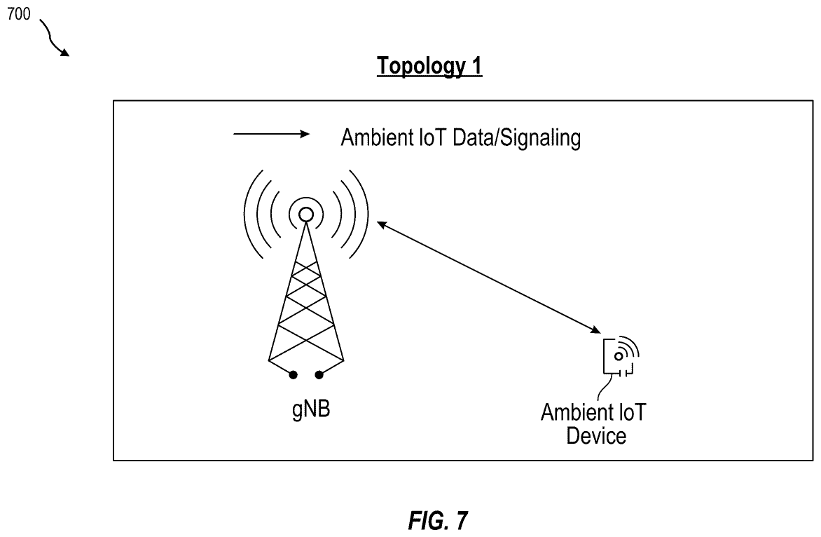

FIG. 7 depicts a diagram 700 illustrating a first topology (Topology 1) of an ambient IoT system. In Topology 1, an ambient IoT device directly and bidirectionally communicates with a gNB. The communication between the gNB and the ambient IoT device includes ambient IoT data and/or signaling. This topology includes the possibility that the gNB transmitting to the ambient IoT device is a different from the gNB receiving from the ambient IoT device.

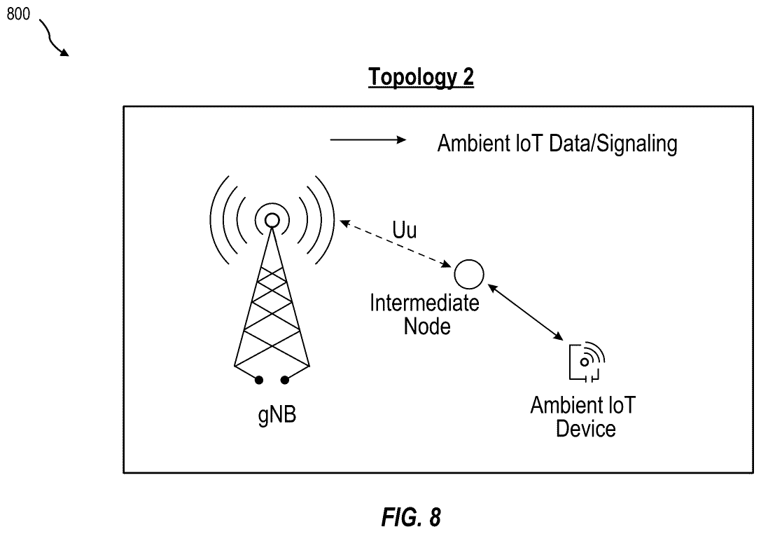

FIG. 8 depicts a diagram 800 illustrating a second topology (Topology 2) of an ambient IoT system. In Topology 2, an ambient IoT device communicates bidirectionally with an intermediate node between the ambient IoT device and a gNB. In this topology, the intermediate node can be a user equipment (UE), a relay device, a repeater device, an integrated access and backhaul (IAB) device, etc. that is capable of an ambient IoT operation. The intermediate node transfers the information between the gNB and the ambient IoT device. In some cases, the ambient IoT device may measure a downlink signal strength from the gNB (e.g., per Topology 1), and from the intermediate node (e.g., per Topology 2).

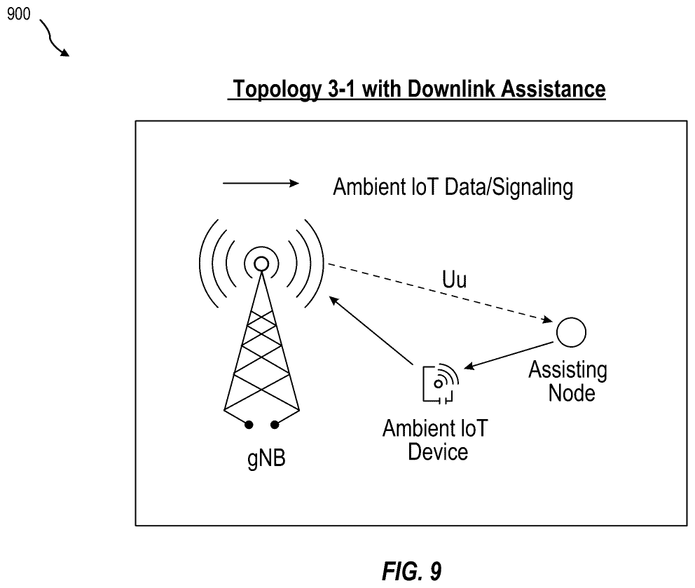

FIG. 9 depicts a diagram 900 illustrating a third topology of an ambient IoT system with downlink assistance (Topology 3-1). As depicted, an ambient IoT device transmits data and/or signalling to a gNB, and receives data and/or signalling from an assisting node (e.g., the assisting node for downlink operations). The assisting node can be a relay device, an IAB device, a UE, or a repeater device which is capable of operating as an ambient IoT device.

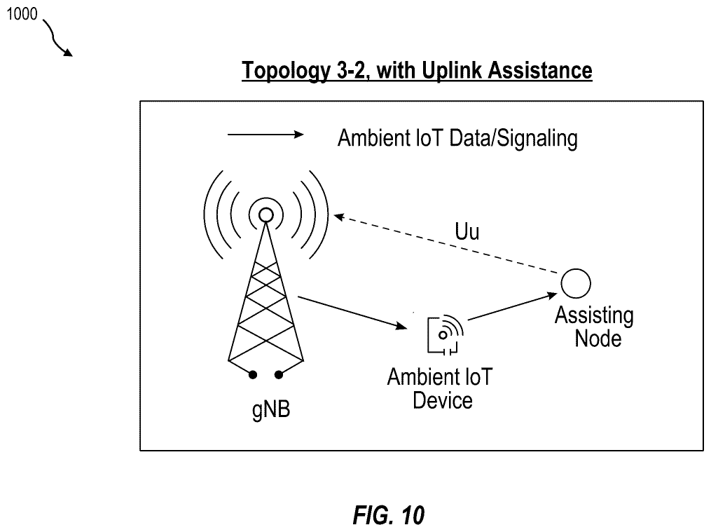

FIG. 10 depicts a diagram 1000 illustrating a third topology of an ambient IoT system with uplink assistance (Topology 3-2). As depicted, an ambient IoT device receives data and/or signalling from a gNB, and transmits data and/or signalling to an assisting node (e.g., the assisting node for uplink operations).

### Overview of Random Access Channel (RACH) Procedure

RACH stands for random access channel. It is an essential part of wireless communication systems, including 5G new radio (NR). RACH procedure plays a role in establishing an initial connection (Initial Access) between a user equipment (UE) and a gNodeB (gNB).

The UE may initiate an RACH procedure after receiving a downlink synchronization signal block (SSB) signal from the gNB. In some cases, there may be a one-to-one correspondence between a particular SSB and an RACH occasion or opportunity (RO) (e.g., which can be used by the UE for an RACH transmission). Accordingly, all UEs which may receive a same SSB from the gNB may initialize the RACH procedures in a same RO (e.g., a slot and/or a frequency resource).

In some cases, the UE may utilize an open loop power control so that a received power at the gNB will be roughly same if there are more than one UE selecting a same RO. In the open loop power control, there is no feedback either from the UE to the gNB or from the gNB to the UE. For example, in a wireless system there may be a dedicated pilot channel provided for channel estimation. It is transmitted by the gNB to all subscribers. For example, the UE may receive the pilot channel from the gNB and estimates a power strength (or signal strength) of the pilot channel. Based on this estimate, the UE adjusts its transmit power.

In an ambient internet of things (IoT) system (e.g., the system 600 depicted and described with respect to FIG. 6), uplink operation may be based on backscattering. For example, an ambient IoT device (or tag) backscatters a continuous wave (CW) received from a gNB, with a frequency shift and modulates the CW with its information sequence.

In the ambient IoT system, there may be multiple ambient IoT devices in a cell. In such cases, it is possible that more than one ambient IoT device may choose or select a same RO for a physical RACH (PRACH) transmission (e.g., since all these ambient IoT devices may receive a same SSB, and there is only one RO (for selection) corresponding to one SSB received from the gNB). In some cases, to achieve satisfying performance for all ambient IoT devices selecting a same RO, it is desirable to have roughly a same receiving power from all the ambient IoT devices.

In NR, a near-far problem is one of detecting or filtering out a weaker signal amongst stronger signals. For example, one UE that is close to a gNB and another UE that is far from the gNB may both attempt to interact with the gNB at a same time, which is known as the near-far problem. The signal from the UE that is near the gNB may be significantly stronger than the signal from the UE that is far away, which can lead to the loss or significant degradation of the signal from the far away UE. Reduced network bandwidth and coverage may result from this.

In NR, the near-far problem is mitigated through an open loop power control. As noted above, based on a received signal strength of a downlink signal (such as, an synchronization signal block (SSB)/system information block (SIB)) from the gNB, the UE calculates transmission power needed for an uplink PRACH transmission (e.g., with assumption of channel reciprocity, which is generally true for time division duplex (TDD) system). TDD uses a same frequency for each duplex direction, with a frame that includes different time periods and slots for uplink or downlink communications.

In the ambient IoT system, the ambient IoT device may not have a capability of power control. For example, the ambient IoT device may only backscatter the CW received from the gNB and does not have a power amplifier (PA) (e.g., to adjust transmission power of any signal/transmission). So, when the multiple ambient IoT device may use the same RO for the PRACH transmission, then a received power of the PRACH transmission from different ambient IoT devices may be significantly different. In such circumstances, the ambient IoT device that may be at an edge of the cell may fail the RACH procedure (and retransmission), which will lead to excess delay and more energy consumption for successfully completing the RACH procedure.

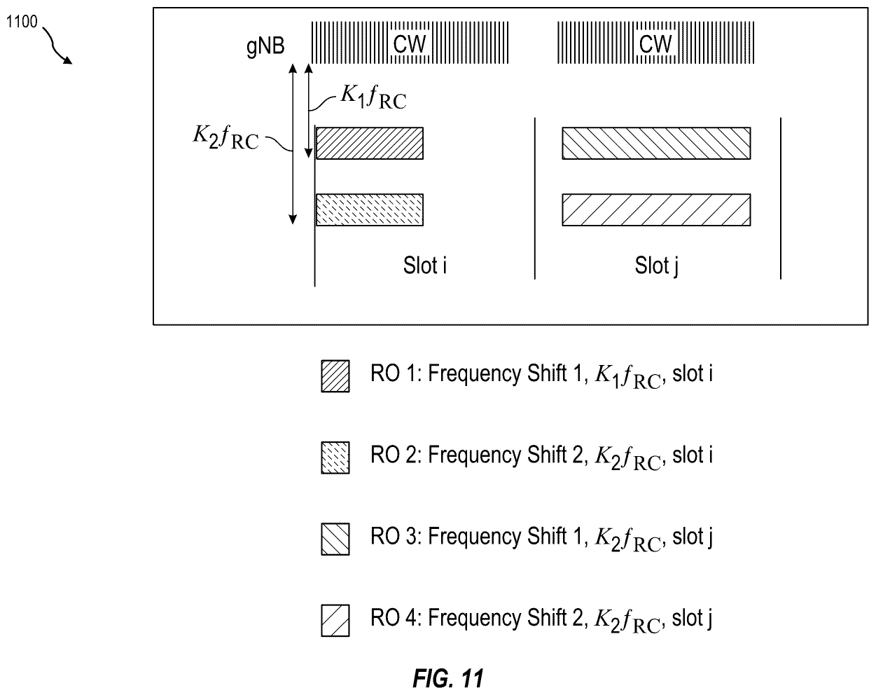

Since the ambient IoT device may not have the capability of power control, to address the near-far problem, one solution may be to provide more than one RO (e.g., an RO pool with multiple ROs) corresponding to one SSB. As illustrated in a diagram 1100 of FIG. 11, different ROs may be characterized by different frequency shifts and/or different times/slots. For example, RO1 is associated with frequency shift 1 and slot i, RO2 is associated with frequency shift 2 and slot i, etc. By providing more than one RO for an SSB, it may be possible to have a similar received signal power at a reader (e.g., which is receiving transmissions from one or more ambient IoT devices) when the multiple ambient IoT devices may select a same RO to transmit the PRACH transmission.

In some cases, the ambient IoT device may select one RO from the RO pool based on signal strength of received downlink signals. For example, using a downlink signal, the gNB may first configure the RO pool corresponding to the SSB. The ambient IoT device may estimate a signal strength of the received downlink signal. The ambient IoT device may then select one RO out from the RO pool based on the signal strength of the received downlink signal.

The above-noted solution to address the near-far problem may be applicable for the ambient IoT system with a mono-static topology (e.g., as depicted in FIG. 7 and FIG. 8, where uplink and downlink channels are reciprocal), and not for the ambient IoT system with a third topology (e.g., as depicted in FIG. 9 and FIG. 10). Accordingly, there is a need for techniques to address the near-far problem for the ambient IoT system with a third topology (e.g., by estimating a received signal strength at a gNB (e.g., in Topology 3-1) or an assisting node (e.g., in Topology 3-2) given that a channel is a composition of two separate channels).

### Aspects Related to Physical Random Access Channel (PRACH) RACH Opportunity (RO) Selection for Ambient IoT System with Assisting Node

Aspects of the present disclosure provide apparatuses, methods, processing systems, and computer-readable mediums for managing selection of one or more random access channel (RACH) occasions (ROs) in an ambient internet of things (IoT) system with an assisting node (e.g., for downlink or uplink operations).

In an ambient IoT system with the assisting node for the downlink operations, an ambient IoT device may measure signal strength of a downlink signal transmitted from a gNodeB (gNB). Based on signal strength measurements, the ambient IoT device may estimate a pathloss between the gNB and the ambient IoT device. Based on the estimated pathloss and other measurements (such as a received power of a signal from the assisting node), the ambient IoT device may select an RO from an RO pool (e.g., with multiple ROs) such that a received power of a signal at the gNB from the ambient IoT device is constrained to a limited range to mitigate the above-noted near-far problem.

In the ambient IoT system with the assisting node for the uplink operations, the ambient IoT device may measure signal strength of a sounding signal transmitted from the assisting node. Based on signal strength measurements, the ambient IoT device may estimate a pathloss between the assisting node and the ambient IoT device. Based on the estimated pathloss and other measurements (e.g., such as the received power of the signal from the gNB), the ambient IoT device may select the RO such that a received power of a signal at the assisting node from the ambient IoT device is constrained to a limited range to mitigate the above-noted near-far problem.

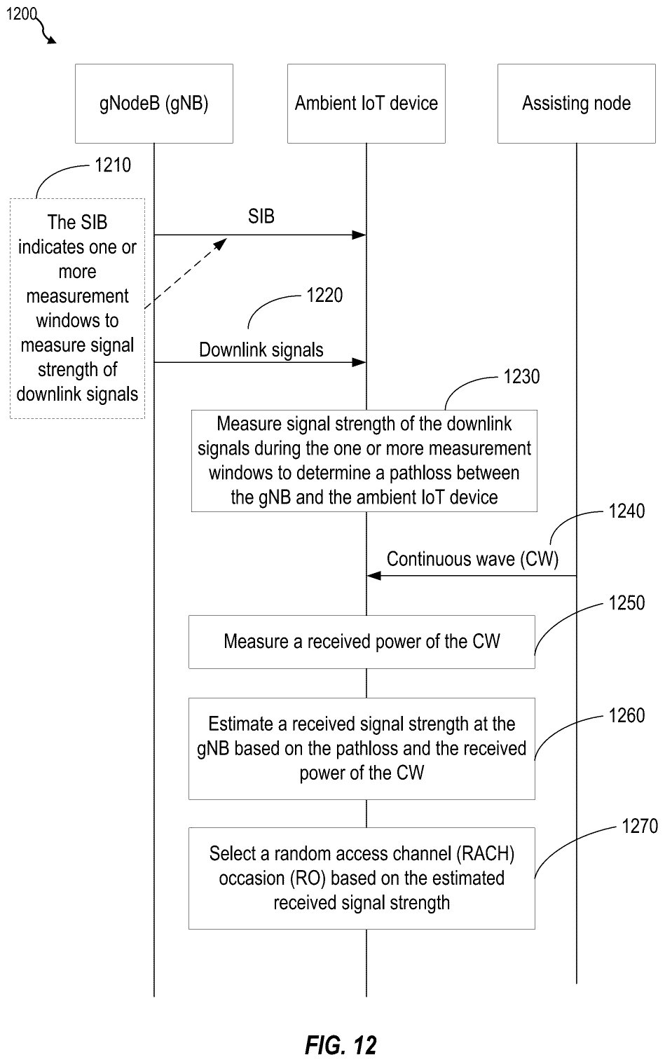

Particular aspects of the subject matter described in this disclosure can be implemented to realize one or more of the following potential advantages. In some examples, the described techniques can address the near-far problem and thereby reduce any transmission delay and energy consumption. The techniques proposed herein for managing the selection of the ROs in the ambient IoT system may be understood with reference to FIG. 12-FIG. 15.

FIG. 12 depicts a first call flow diagram 1200 illustrating example communication among different devices and nodes for managing selection of ROs in an ambient IoT system. A gNB depicted in FIG. 12 may be an example of the BS 102 depicted and described with respect to FIG. 1 and FIG. 3, or the disaggregated BS depicted and described with respect to FIG. 2. An ambient IoT device depicted in FIG. 12 may be an example of the UE 104 depicted and described with respect to FIG. 1 and FIG. 3. An assisting node depicted in FIG. 12 may be an example of the BS 102 depicted and described with respect to FIG. 1 and FIG. 3, or the disaggregated BS depicted and described with respect to FIG. 2. In some cases, the assisting node depicted in FIG. 12 may be an example of the UE 104 depicted and described with respect to FIG. 1 and FIG. 3.

As indicated at 1210, the gNB transmits a system information block (SIB) to the ambient IoT device. In some cases, the SIB may also be transmitted from the assisting node to the ambient IoT device. The SIB indicates one or more measurement windows for the ambient IoT device to measure signal strength of one or more downlink signals from the gNB.

In certain aspects, the gNB may transmit multiple SIBs to the ambient IoT device, which may indicate multiple measurement windows for the ambient IoT device to measure the signal strength of multiple downlink signals from the gNB. In some cases, when the multiple SIBs may indicate more than one measurement window, it may allow for averaging of signal strength measurements of one or more downlink signals performed during the multiple measurement windows.

In certain aspects, a number of measurement windows to measure a number of downlink signals is determined based on inputs from the gNB and the assisting node. For example, the gNB and the assisting node may negotiate with each other to determine the number of measurement windows to measure the signal strength of the one or more downlink signals.

In certain aspects, the number of downlink signals is determined based on inputs from the gNB and the assisting node. For example, the gNB and the assisting node may negotiate with each other to determine the number of downlink signals which can be sent by the gNB to the ambient IoT device.

As indicated at 1220, the gNB transmits the one or more downlink signals to the ambient IoT device. In one example, the one or more downlink signals may include a primary synchronization signal (PSS). In another example, the one or more downlink signals may include a secondary synchronization signal (SSS). In another example the one or more downlink signals may include a synchronization signal block (SSB). In another example, the one or more downlink signals may include a reference signal (RS).

As indicated at 1230, the ambient IoT device measures the signal strength of the one or more downlink signals received from the gNB during the one or more measurement windows (e.g., as indicated by the SIB).

In certain aspects, the ambient IoT device may measure the signal strength of the one or more downlink signals without decoding the one or more downlink signals.

In certain aspects, the ambient IoT device may determine a pathloss between the gNB and the ambient IoT device based on the measured signal strength of the one or more downlink signals. For example, the ambient IoT device may measure some downlink signals received directly from the gNB and infer the pathloss from the gNB to the ambient IoT device.

In certain aspects, the ambient IoT device may determine (or infer) the pathloss between the gNB and the ambient IoT device based on the measured signal strength of the one or more downlink signals and a transmission power associated with the gNB. In some cases, the ambient IoT device may obtain information associated with the transmission power of the gNB from the gNB.

As indicated at 1240, the assisting node transmits a continuous wave (CW) to the ambient IoT device. The CW is an electromagnetic wave of constant amplitude and frequency, such as a sine wave, that is considered to be of infinite duration.

As indicated at 1250, the ambient IoT device measures a received power of (or associated with) the CW. For example, during a random access channel (RACH) procedure, the ambient IoT device receives the CW from the assisting node, and measures the received power of the CW.

As indicated at 1260, the ambient IoT device estimates a received signal strength at the gNB based on the pathloss and the received power of the CW.

As indicated at 1270, the ambient IoT device selects or chooses at least one RACH occasion (RO) (e.g., from multiple ROs) based on the estimated received signal strength at the gNB. In one example, the ambient IoT device may select a first RO based on a first value of the estimated received signal strength at the gNB. In another example, the ambient IoT device may select a second RO based on a second value of the estimated received signal strength at the gNB. The ambient IoT device may transmit one or more RACH transmissions in the selected RO.

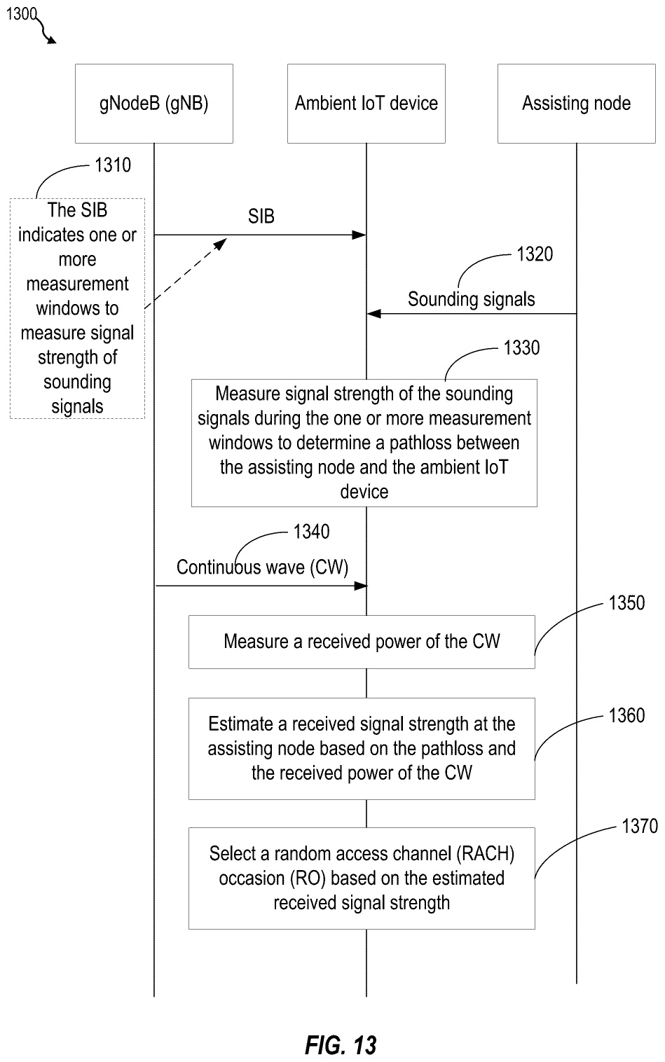

FIG. 13 depicts a second call flow diagram 1300 illustrating example communication among different devices and nodes for managing selection of ROs in an ambient IoT system. A gNB depicted in FIG. 13 may be an example of the BS 102 depicted and described with respect to FIG. 1 and FIG. 3, or the disaggregated BS depicted and described with respect to FIG. 2. An ambient IoT device depicted in FIG. 13 may be an example of the UE 104 depicted and described with respect to FIG. 1 and FIG. 3. An assisting node depicted in FIG. 13 may be an example of the BS 102 depicted and described with respect to FIG. 1 and FIG. 3, or the disaggregated BS depicted and described with respect to FIG. 2. In some cases, the assisting node depicted in FIG. 13 may be an example of the UE 104 depicted and described with respect to FIG. 1 and FIG. 3.

As indicated at 1310, the gNB transmits an SIB to the ambient IoT device. The SIB indicates one or more measurement windows for the ambient IoT device to measure signal strength of one or more sounding signals from the assisting node.

In certain aspects, the gNB may transmit multiple SIBs to the ambient IoT device, which may indicate multiple measurement windows for the ambient IoT device to measure the signal strength of multiple sounding signals from the assisting node. In some cases, when the multiple SIBs may indicate more than one measurement window, it may allow for averaging of signal strength measurements of one or more sounding signals performed during the multiple measurement windows.

In certain aspects, a number of measurement windows to measure a number of sounding signals is determined based on inputs from the gNB and the assisting node. For example, the gNB and the assisting node may negotiate with each other to determine the number of measurement windows for the assisting node to measure the signal strength of the one or more sounding signals.

In certain aspects, the number of sounding signals is determined based on inputs from the gNB and the assisting node. For example, the gNB and the assisting node may negotiate with each other to determine the number of sounding signals which can be sent by the assisting node to the ambient IoT device.

As indicated at 1320, the assisting node transmits the one or more sounding signals to the ambient IoT device. For example, the one or more sounding signals may include a sounding reference signal (SRS).

As indicated at 1330, the ambient IoT device measures signal strength of the one or more sounding signals received from the assisting node during the one or more measurement windows (e.g., as indicated by the gNB).

In certain aspects, the ambient IoT device may measure the signal strength of the one or more sounding signals received from the assisting node without decoding the one or more sounding signals.

In certain aspects, the ambient IoT device may determine a pathloss between the assisting node and the ambient IoT device based on the measured signal strength of the one or more sounding signals. For example, the ambient IoT device may measure some sounding signals received directly from the assisting node and infer the pathloss between the assisting node and the ambient IoT device. In some cases, the ambient IoT device may be instructed by the gNB about how/when to measure the sounding signals.

As indicated at 1340, the gNB transmits a CW to the ambient IoT device.

As indicated at 1350, the ambient IoT device measures a received power of (or associated with) the CW. For example, during an RACH procedure, the ambient IoT device receives the CW from the gNB, and measures the received power of the CW.

As indicated at 1360, the ambient IoT device estimates a received signal strength at the assisting node based on: the pathloss between the assisting node and the ambient IoT device, the received power of the CW, and/or a pathloss from the gNB to the ambient IoT device. In some cases, the ambient IoT device may estimate the pathloss from the gNB to the ambient IoT device by measuring some downlink signals from the gNB.

As indicated at 1370, the ambient IoT device selects at least one RO (e.g., from multiple ROs) based on the estimated received signal strength at the assisting node. In one example, the ambient IoT device may select a first RO based on a first value of the estimated received signal strength at the assisting node. In another example, the ambient IoT device may select a second RO based on a second value of the estimated received signal strength at the assisting node. The ambient IoT device may transmit one or more RACH transmissions in the selected RO.

### Example Method for Wireless Communications at a First Wireless Node

FIG. 14 shows an example of a method 1400 for wireless communications at a first wireless node, such as the UE 104 of FIG. 1 and FIG. 3.

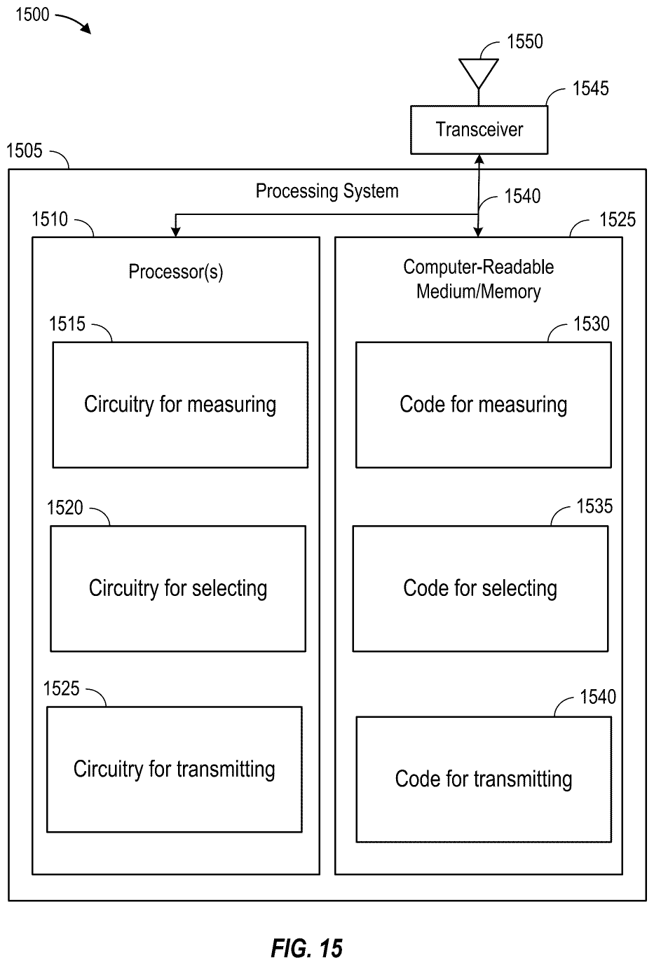

Method 1400 begins at step 1410 with the first wireless node measuring one or more signals received from a second wireless node. In some cases, the operations of this step refer to, or may be performed by, circuitry for measuring and/or code for measuring as described with reference to FIG. 15.

Method 1400 then proceeds to step 1420 with the first wireless node measuring a continuous wave (CW) received from a third wireless node. In some cases, the operations of this step refer to, or may be performed by, circuitry for measuring and/or code for measuring as described with reference to FIG. 15.

Method 1400 then proceeds to step 1430 with the first wireless node selecting a random access channel (RACH) occasion (RO) based on measurements associated with the one or more signals and the CW. In some cases, the operations of this step refer to, or may be performed by, circuitry for selecting and/or code for selecting as described with reference to FIG. 15.

Method 1400 then proceeds to step 1440 with the first wireless node transmitting an RACH transmission in the selected RO. In some cases, the operations of this step refer to, or may be performed by, circuitry for transmitting and/or code for transmitting as described with reference to FIG. 15.

In certain aspects, the method 1400 further includes the first wireless node receiving at least one system information block (SIB) indicating one or more measurement windows to measure signal strength of the one or more signals from the second wireless node.

In certain aspects, at least one of: a number of the one or more measurement windows or a number of the one or more signals is based on inputs from the second wireless node and the third wireless node.

In certain aspects, the method 1400 further includes the first wireless node receiving the one or more signals from the second wireless node; measuring the signal strength of the one or more signals during the one or more measurement windows; and determining a pathloss from the second wireless node to the first wireless node based on the signal strength of the one or more signals and a transmission power of the second wireless node.

In certain aspects, the method 1400 further includes the first wireless node receiving the CW from the third wireless node and measuring a received power of the CW.

In certain aspects, the method 1400 further includes the first wireless node estimating a received signal strength at the second wireless node based on the pathloss and the received power of the CW.

In certain aspects, the method 1400 further includes the first wireless node selecting the RO based on the estimated received signal strength at the second wireless node.

In certain aspects, the first wireless node includes an ambient internet of things (IoT) tag; the second wireless node includes a network entity (e.g., gNodeB (gNB)); the third wireless node includes a UE, a relay device, a repeater device, or an integrated access and backhaul (IAB) device; and the one or more signals include at least one of: a primary synchronization signal (PSS), a secondary synchronization signal (SSS), or a reference signal (RS).

In certain aspects, the first wireless node includes an ambient IoT tag; the second wireless node includes a UE, a relay device, a repeater device, or an IAB device; the third wireless node includes a network entity; and the one or more signals include one or more sounding reference signals.

In one aspect, the method 1400, or any aspect related to it, may be performed by a first wireless node, such as a communications device 1500 of FIG. 15, which includes various components operable, configured, or adapted to perform the method 1400. The communications device 1500 is described below in further detail.

Note that FIG. 14 is just one example of a method, and other methods including fewer, additional, or alternative steps are possible consistent with this disclosure.

### Example Communications Device

FIG. 15 depicts aspects of an example communications device 1500. In some aspects, the communications device 1500 is a first wireless node, such as UE 104 described above with respect to FIG. 1 and FIG. 3.

The communications device 1500 includes a processing system 1505 coupled to a transceiver 1545 (e.g., a transmitter and/or a receiver). The transceiver 1545 is configured to transmit and receive signals for the communications device 1500 via an antenna 1550, such as the various signals as described herein. The processing system 1505 may be configured to perform processing functions for the communications device 1500, including processing signals received and/or to be transmitted by the communications device 1500.

The processing system 1505 includes one or more processors 1510. In various aspects, the one or more processors 1510 may be representative of one or more of receive processor 358, transmit processor 364, TX MIMO processor 366, and/or controller/processor 380, as described with respect to FIG. 3. The one or more processors 1510 are coupled to a computer-readable medium/memory 1525 via a bus 1540. In certain aspects, the computer-readable medium/memory 1525 is configured to store instructions (e.g., computer-executable code) that when executed by the one or more processors 1510, cause the one or more processors 1510 to perform the method 1400 described with respect to FIG. 14, and/or any aspect related to it. Note that reference to a processor performing a function of communications device 1500 may include the one or more processors 1510 performing that function of communications device 1500.

In the depicted example, computer-readable medium/memory 1525 stores code (e.g., executable instructions), such as code for measuring 1530, code for selecting 1535, and code for transmitting 1540. Processing of the code for measuring 1530, the code for selecting 1535, and the code for transmitting 1540 may cause the communications device 1500 to perform the method 1400 described with respect to FIG. 14, and/or any aspect related to it.

The one or more processors 1510 include circuitry configured to implement (e.g., execute) the code stored in the computer-readable medium/memory 1525, including circuitry such as circuitry for measuring 1515, circuitry for selecting 1520, and circuitry for transmitting 1525. Processing with the circuitry for measuring 1515, the circuitry for selecting 1520, and the circuitry for transmitting 1525 may cause the communications device 1500 to perform the method 1400 described with respect to FIG. 14, and/or any aspect related to it.

Various components of the communications device 1500 may provide means for performing the method 1400 described with respect to FIG. 14, and/or any aspect related to it. For example, means for transmitting, sending or outputting for transmission may include transceivers 354 and/or antenna(s) 352 of the UE 104 illustrated in FIG. 3 and/or the code for transmitting 1540, the circuitry for transmitting 1525, the transceiver 1545 and the antenna 1550 of the communications device 1500 in FIG. 15.

Means for receiving or obtaining may include transceivers 354 and/or antenna(s) 352 of the UE 104 illustrated in FIG. 3 and/or the transceiver 1545 and the antenna 1550 of the communications device 1500 in FIG. 15.

Means for measuring may include processor 380, transceivers 354 and/or antenna(s) 352 of the UE 104 illustrated in FIG. 3 and/or the code for measuring 1530, the circuitry for measuring 1515, the transceiver 1545 and the antenna 1550 of the communications device 1500 in FIG. 15.

Means for selecting may include processor 380, transceivers 354 and/or antenna(s) 352 of the UE 104 illustrated in FIG. 3 and/or the code for selecting 1535, the circuitry for selecting 1520, the transceiver 1545 and the antenna 1550 of the communications device 1500 in FIG. 15.

In some cases, rather than actually transmitting, for example, signals and/or data, a device may have an interface to output signals and/or data for transmission (a means for outputting). For example, a processor may output signals and/or data, via a bus interface, to a radio frequency (RF) front end for transmission. In various aspects, an RF front end may include various components, including transmit and receive processors, transmit and receive MIMO processors, modulators, demodulators, and the like, such as depicted in the examples in FIG. 3.

In some cases, rather than actually receiving signals and/or data, a device may have an interface to obtain the signals and/or data received from another device (a means for obtaining). For example, a processor may obtain (or receive) the signals and/or data, via a bus interface, from an RF front end for reception. In various aspects, an RF front end may include various components, including transmit and receive processors, transmit and receive MIMO processors, modulators, demodulators, and the like, such as depicted in the examples in FIG. 3. Notably, FIG. 15 is an example, and many other examples and configurations of communication device 1500 are possible.

### Example Clauses

Implementation examples are described in the following numbered clauses:

Clause 1: A method for wireless communications at a first wireless node, comprising: measuring one or more signals received from a second wireless node; measuring a continuous wave (CW) received from a third wireless node; selecting a random access channel (RACH) occasion (RO) based on measurements associated with the one or more signals and the CW; and transmitting an RACH transmission in the selected RO.

Clause 2: The method of clause 1, further comprising receiving at least one system information block (SIB) indicating one or more measurement windows to measure signal strength of the one or more signals from the second wireless node.

Clause 3: The method of clause 2, wherein at least one of: a number of the one or more measurement windows or a number of the one or more signals is based on inputs from the second wireless node and the third wireless node.

Clause 4: The method of clause 2, further comprising: receiving the one or more signals from the second wireless node; measuring the signal strength of the one or more signals during the one or more measurement windows; and determining a pathloss from the second wireless node to the first wireless node based on the signal strength of the one or more signals and a transmission power of the second wireless node.

Clause 5: The method of clause 4, further comprising: receiving the CW from the third wireless node; and measuring a received power of the CW.

Clause 6: The method of clause 5, further comprising estimating a received signal strength at the second wireless node based on the pathloss and the received power of the CW.

Clause 7: The method of clause 6, wherein the selecting comprises selecting the RO based on the estimated received signal strength at the second wireless node.

Clause 8: The method of any one of clauses 1-7, wherein: the first wireless node comprises an ambient internet of things (IoT) tag; the second wireless node comprises a network entity; the third wireless node comprises a user equipment (UE), a relay device, a repeater device, or an integrated access and backhaul (IAB) device; and the one or more signals comprise at least one of: a primary synchronization signal (PSS), a secondary synchronization signal (SSS), or a reference signal (RS).

Clause 9: The method of any one of clauses 1-7, wherein: the first wireless node comprises an ambient internet of things (IoT) tag; the second wireless node comprises a user equipment (UE), a relay device, a repeater device, or an integrated access and backhaul (IAB) device; the third wireless node comprises a network entity; and the one or more signals comprise one or more sounding reference signals.

Clause 10: An apparatus, comprising: a memory comprising executable instructions; and one or more processors configured, individually or in any combination, to execute the executable instructions and cause the apparatus to perform a method in accordance with any one of Clauses 1-9.

Clause 11: An apparatus, comprising means for performing a method in accordance with any one of Clauses 1-9.

Clause 12: A non-transitory computer-readable medium comprising executable instructions that, when executed by one or more processors of an apparatus, cause the apparatus to perform a method in accordance with any one of Clauses 1-9.

Clause 13: A computer program product embodied on a computer-readable storage medium comprising code for performing a method in accordance with any one of Clauses 1-9.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, “a processor,” “at least one processor” or “one or more processors” generally refers to a single processor configured to perform one or multiple operations or multiple processors configured to collectively perform one or more operations. In the case of multiple processors, performance the one or more operations could be divided amongst different processors, though one processor may perform multiple operations, and multiple processors could collectively perform a single operation. Similarly, “a memory,” “at least one memory” or “one or more memories” generally refers to a single memory configured to store data and/or instructions, multiple memories configured to collectively store data and/or instructions.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. An apparatus for wireless communications at a first wireless node, comprising:
a memory comprising instructions; and
one or more processors configured, individually or in any combination, to execute the instructions and cause the apparatus to:
measure one or more signals received from a second wireless node;
measure a continuous wave (CW) received from a third wireless node;
select a random access channel (RACH) occasion (RO) based on measurements associated with the one or more signals and the CW; and
transmit an RACH transmission in the selected RO.

2. The apparatus of claim 1, wherein the one or more processors are configured, individually or in any combination, to execute the instructions and cause the apparatus to receive at least one system information block (SIB) indicating one or more measurement windows to measure signal strength of the one or more signals from the second wireless node.

3. The apparatus of claim 2, wherein at least one of: a number of the one or more measurement windows or a number of the one or more signals is based on inputs from the second wireless node and the third wireless node.

4. The apparatus of claim 2, wherein the one or more processors are configured, individually or in any combination, to execute the instructions and cause the apparatus to:
receive the one or more signals from the second wireless node;
measure the signal strength of the one or more signals during the one or more measurement windows; and
determine a pathloss from the second wireless node to the first wireless node based on the signal strength of the one or more signals and a transmission power of the second wireless node.

5. The apparatus of claim 4, wherein the one or more processors are configured, individually or in any combination, to execute the instructions and cause the apparatus to:
receive the CW from the third wireless node; and
measure a received power of the CW.

6. The apparatus of claim 5, wherein the one or more processors are configured, individually or in any combination, to execute the instructions and cause the apparatus to estimate a received signal strength at the second wireless node based on the pathloss and the received power of the CW.

7. The apparatus of claim 6, wherein the one or more processors are configured, individually or in any combination, to execute the instructions and cause the apparatus to select the RO based on the estimated received signal strength at the second wireless node.

8. The apparatus of claim 1, wherein:
the first wireless node comprises an ambient internet of things (IoT) tag;
the second wireless node comprises a network entity;
the third wireless node comprises a user equipment (UE), a relay device, a repeater device, or an integrated access and backhaul (IAB) device; and
the one or more signals comprise at least one of: a primary synchronization signal (PSS), a secondary synchronization signal (SSS), or a reference signal (RS).

9. The apparatus of claim 1, wherein:
the first wireless node comprises an ambient internet of things (IoT) tag;
the second wireless node comprises a user equipment (UE), a relay device, a repeater device, or an integrated access and backhaul (IAB) device;
the third wireless node comprises a network entity; and
the one or more signals comprise one or more sounding reference signals.

10. A method for wireless communications at a first wireless node, comprising:
measuring one or more signals received from a second wireless node;
measuring a continuous wave (CW) received from a third wireless node;
selecting a random access channel (RACH) occasion (RO) based on measurements associated with the one or more signals and the CW; and
transmitting an RACH transmission in the selected RO.

11. The method of claim 10, further comprising receiving at least one system information block (SIB) indicating one or more measurement windows to measure signal strength of the one or more signals from the second wireless node.

12. The method of claim 11, wherein at least one of: a number of the one or more measurement windows or a number of the one or more signals is based on inputs from the second wireless node and the third wireless node.

13. The method of claim 11, further comprising:
receiving the one or more signals from the second wireless node;
measuring the signal strength of the one or more signals during the one or more measurement windows; and
determining a pathloss from the second wireless node to the first wireless node based on the signal strength of the one or more signals and a transmission power of the second wireless node.

14. The method of claim 13, further comprising:
receiving the CW from the third wireless node; and
measuring a received power of the CW.

15. The method of claim 14, further comprising estimating a received signal strength at the second wireless node based on the pathloss and the received power of the CW.

16. The method of claim 15, wherein the selecting comprises selecting the RO based on the estimated received signal strength at the second wireless node.

17. The method of claim 10, wherein:
the first wireless node comprises an ambient internet of things (IoT) tag;
the second wireless node comprises a network entity;
the third wireless node comprises a user equipment (UE), a relay device, a repeater device, or an integrated access and backhaul (IAB) device; and
the one or more signals comprise at least one of: a primary synchronization signal (PSS), a secondary synchronization signal (SSS), or a reference signal (RS).

18. The method of claim 10, wherein:
the first wireless node comprises an ambient internet of things (IoT) tag;
the second wireless node comprises a user equipment (UE), a relay device, a repeater device, or an integrated access and backhaul (IAB) device;
the third wireless node comprises a network entity; and
the one or more signals comprise one or more sounding reference signals.

19. A non-transitory computer-readable medium comprising computer-executable instructions that, when executed by one or more processors of a first wireless node, cause the first wireless node to perform a method of wireless communications, comprising:
measuring one or more signals received from a second wireless node;
measuring a continuous wave (CW) received from a third wireless node;
selecting a random access channel (RACH) occasion (RO) based on measurements associated with the one or more signals and the CW; and
transmitting an RACH transmission in the selected RO.

20. The non-transitory computer-readable medium of claim 19, wherein:
the first wireless node comprises an ambient internet of things (IoT) tag;
the second wireless node comprises a network entity;
the third wireless node comprises a user equipment (UE), a relay device, a repeater device, or an integrated access and backhaul (IAB) device; and
the one or more signals comprise at least one of: a primary synchronization signal (PSS), a secondary synchronization signal (SSS), or a reference signal (RS).
